(19) United States
(12) Patent Application Publication
(10) Pub. No.: US 2004/0213448 A1
(43) Pub. Date: Oct. 28, 2004

(54) Apparatus for recognizing counterfeit currency and method thereof

(75) Inventors: I-Chang Jou, Kaohsiung (TW); Hen-Chang Chang, Tainan (TW)

Correspondence Address: BACON & THOMAS, PLLC, 625 SLATERS LANE, FOURTH FLOOR, ALEXANDRIA, VA, 22314

(73) Assignee: ASN Technology Corp., Tainan (TW)

(21) Appl. No.: 10/423,987

(22) Filed: Apr. 28, 2003

(51) Int. Cl. G06K 9/00; G06K 9/46

(52) U.S. Cl. 382/135; 382/190; 382/156

(57) ABSTRACT

Apparatus and method for recognizing counterfeit currency are disclosed. The apparatus comprises capture unit for capturing a digital image of a currency bill to be recognized, a data storage for storing parameters, features, weights, and a feature identification instruction, feature-capturing unit for capturing features of the bill, neural network recognition unit for comparing the features of the bill with that of an authentic bill by performing an back propagation algorithm and using a plastic perception network as a training kernel, and output means for displaying a comparison result.

### BACKGROUND OF THE INVENTION

1. Field of the Invention

The present invention relates to an apparatus for recognition and, more particularly, to an apparatus of recognizing counterfeit currency and method thereof with improved characteristics.

2. Description of Related Art

The counterfeit currency is a problem that grows dramatically in recent years. The increasing counterfeit currency is contributed by the advent of color photocopy machines in some ways. It is uneasy, or unreliable to identify tiny variations between the features of a counterfeit bill and those of an authentic one by an ordinary person without professional tools for recognition. Hence, in one aspect many governments issue bills with more sophisticated printing patterns for facilitating the counterfeit currency recognition. To meet the demand for recognizing the counterfeit currency, some companies develop sophisticated recognition equipment such as UV marker pens for recognition. However, the percentage for successfully validating a counterfeit bill is low for these existing technologies.

Therefore, it is desirable to provide a novel apparatus for recognizing counterfeit currency and method thereof in order to mitigate and/or obviate the aforementioned problems.

### SUMMARY OF THE INVENTION

An object of the present invention is to provide an apparatus for recognizing or validating the counterfeit currency and method for greatly increasing a percentage of successfully validating a counterfeit bill.

Another object of the present invention is to provide an apparatus for recognizing counterfeit currency and method for recognizing valuable papers circulated in different countries.

Another object of the present invention is to provide an apparatus of recognizing counterfeit currency and method thereof wherein features of an authentic bill are adapted to update.

In one aspect of the present invention there is provided an apparatus for recognizing counterfeit currency, comprising: an image-capturing unit for obtaining and capturing a digital image of a currency bill to be validated or recognized; a feature-capturing unit for capturing features of said digital image of the currency bill, wherein said features are characters, weights, system parameters, or threshold limits specific to said currency bill; a data storage for storing a plurality of parameters, a plurality of features, a plurality of weights, a plurality of threshold limit values, or a plurality of system parameters; and a neural network recognition unit having a plurality of sub-networks each updating a weight of the sub-networks based on a backpropagation algorithm; wherein the neural network recognition unit uses a plastic perception network as a training kernel performed by the sub-networks, and the neural network recognition unit compares one of the features of the digital image of the currency bill with that of an authentic bill and generates a comparison result for outputting a output unit.

In another aspect of the present invention there is provided a method of recognizing counterfeit currency, comprising the steps of (A) providing a currency bill to be recognized; (B) inserting said currency bill into a image-capturing unit for capturing a digital image of the currency bill; (C) determining a denomination of the currency bill by analyzing the digital image of the currency bill; (D) capturing features of the digital image of the currency bill by the feature-capturing unit; (E) comparing the fetched features of the digital image of the currency bill with those of an authentic bill by neural network recognition unit by using a back propagation algorithm and a plastic perception network as a training kernel and generating a comparison result; and (F) displaying the comparison result on output means.

Other objects, advantages, and novel features of the invention will become more apparent from the detailed description when taken in conjunction with the accompanying drawings.

### BRIEF DESCRIPTION OF THE DRAWINGS

FIG. 1 is a block diagram of a counterfeit currency recognition apparatus according to a preferred embodiment of the invention.

FIG. 2A schematically depicts a structure of back propagation algorithm based neural network according to the invention.

FIG. 2B schematically depicts a structure of plastic perception network according to the invention.

FIG. 3 is a flow chart showing a sequence of steps performed by the counterfeit currency recognition apparatus of FIG. 1.

FIG. 4 is an appearance of a counterfeit currency recognition apparatus according to a preferred embodiment of the invention.

### DETAILED DESCRIPTION OF THE PREFERRED EMBODIMENT

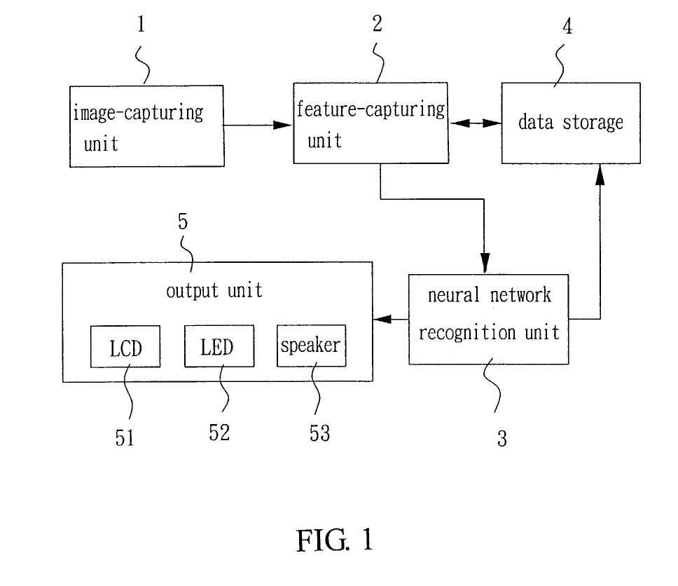

With reference to FIG. 1, there is shown a counterfeit currency recognition apparatus constructed in accordance with the invention comprising an image-capturing unit 1, a feature capture unit 2, a neural network recognition unit 3, a data storage 4, and an output unit 5. Each component is described in detail below.

The image-capturing unit 1 is responsible for capturing a digital image of a currency bill to be recognized. In the embodiment, the image-capturing unit 1 is implemented as an optical image-capturing unit 1 such as back lit optical scanner. Preferably, it is an optical scanner of paper feed type or high-speed optical scanner of paper distribution type. More preferably, it is a back-lit charge coupled device (CCD)/complementary metal-oxide semiconductor (CMOS) based image-capturing unit 1. The CCD/CMOS based image-capturing unit 1 is very helpful for reducing the whole time for recognizing the counterfeit currency because of the high-speed-image-capturing of the optical scanner. The feature-capturing unit 2 is responsible for capturing features of the digital image of the currency bill optionally commanded by an input feature identification instruction from a memory of the data storage 4. The features comprise one or more embossing prints, one or more hidden lines, a patterned register, and one or more laser labels of an authentic bill. The feature-capturing unit 2 or the neural network recognition unit 3 is implemented as a microprocessor or a digital signal processor (DSP). The neural network recognition unit 3 further compares the captured features of the currency bill to be recognized with those of an authentic bill by using a back propagation algorithm and a plastic perception network as training and identifying kernels performed by a neural network. A comparison result is then sent to the output unit 5, which comprises a liquid crystal display (LCD) 51, a light-emitting diode (LED) 52, and a speaker 53. Note that the feature capture unit 2, the neural network recognition unit 3, and the data storage 4 can be implemented in an integrated circuit (IC).

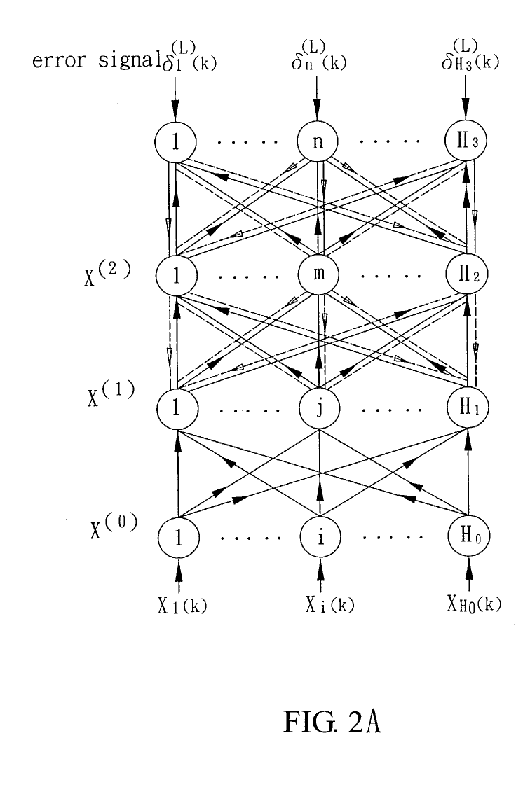

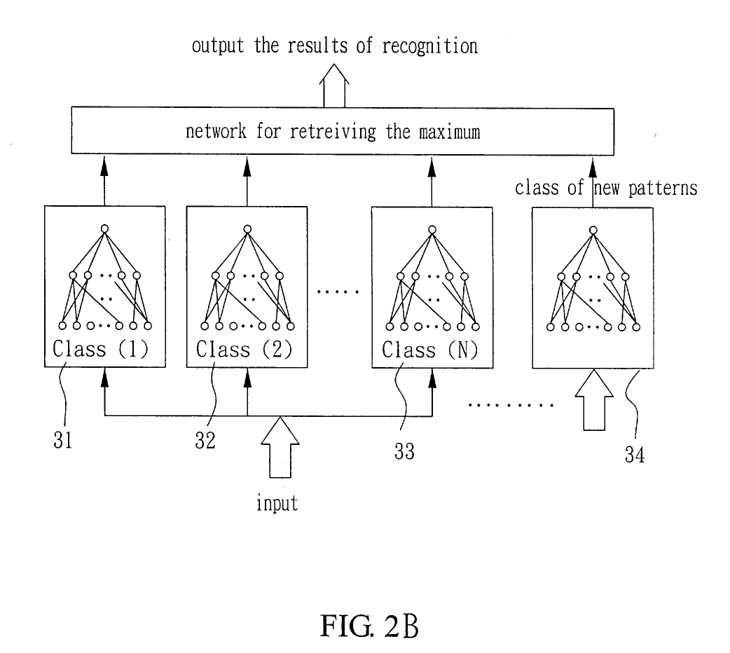

With reference to FIGS. 2A and 2B, they depict structures of back-propagation-algorithm-based neural network and plastic perception network served as a neural network respectively. The neural network recognition unit 3 comprises a plurality of sub-networks (e.g., neurons) 31,32, and 33. In the embodiment, for example, the sub-network 31 performs a backpropagation algorithm for identifying one of the features of the currency bill. The backpropagation is a supervised, error-correcting learning algorithm, it realizes a gradient descent in error (where error means the difference of the actual output of the system and a target output)(Referring Rumelhart & McClelland, 1986). The plastic perception network comprises a plurality of backpropagation algorithm sub-networks each having a single output. Hence, each of the sub-networks 31, 32, and 33 can converge. Further, there is no need to train all of the sub-networks such as the sub-networks 31, 32, and 33 when a new sub-network 34 (i.e., a new feature to be identified) is added in the plastic perception network.

Referring to FIG. 1 again, the data storage 4 is implemented as a database containing a plurality of parameters such as features, weights, threshold limit values, and system parameters. In the embodiment, the features are used by the sub-networks 31, 32, 33, and 34 to recognize a currency bill. The weights and the threshold limit values are used to establish a neural network. For example, the weights and the threshold limit values are used by the neural network recognition unit 3 to construct a back-propagation-algorithm and a plastic perception network.

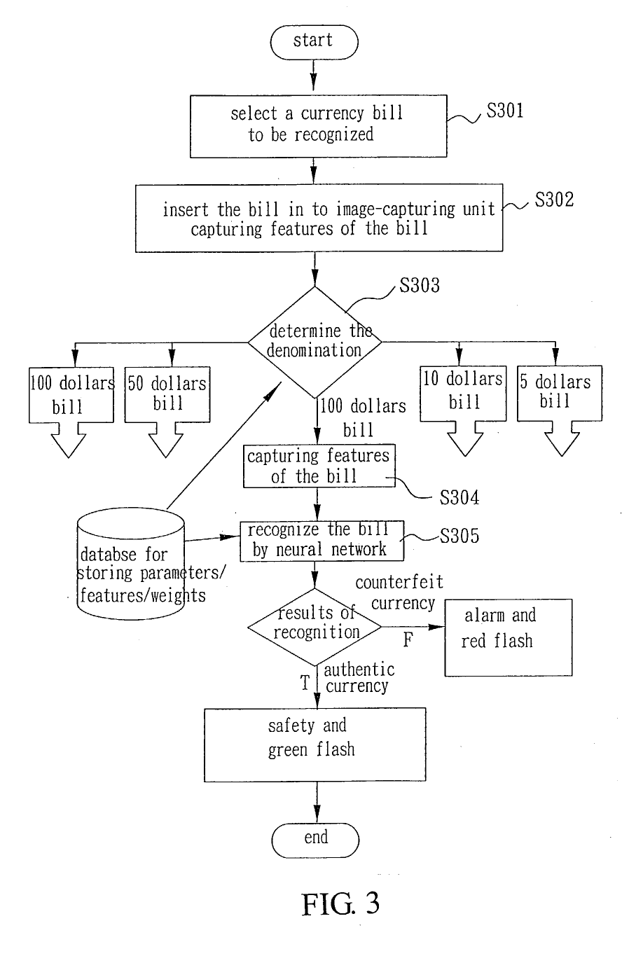

With reference to FIG. 3, the steps performed by the counterfeit currency recognition apparatus for authenticating a currency bill will be described. Beginning in step S301, select a currency bill to be recognized. In step S302, insert the bill into the image-capturing unit 1 so that the image-capturing unit 1 can capture a digital image of the bill. Next, in step S303, a denomination of the bill is determined by analyzing the digital image of the currency bill. Following steps will be described with respect to a currency bill identified to have a denomination of 100 dollars. In step S304, the feature capture unit 2 captures features (e.g., one or more embossing prints, one or more hidden lines, a patterned register, and one or more laser labels) of the digital image of the bill. In step S305, the captured features are sent to the neural network recognition unit 3 for recognition by comparing the captured features with those of an authentic bill. An alarm will be generated by the speaker 53, a red light or flashing red light will be emitted by the LED 52, and a warning message will be shown on the LCD 51 respectively if the comparison result is false (i.e., the bill is rendered invalid). To the contrary, the LED 52 will emit a green light and a safe message will be shown on the LCD 51 respectively if the comparison result is true (i.e., the bill is authentic).

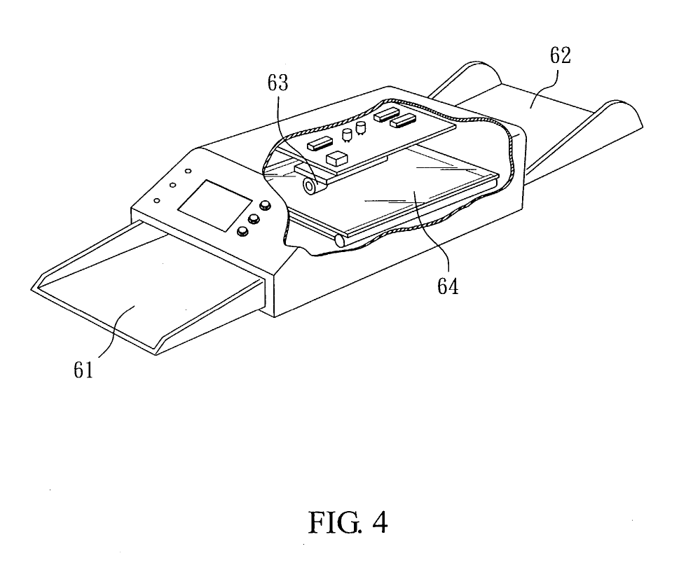

With reference to FIG. 4, the currency bill is inputted to a bill inlet 61, and then the CCD/CMOS image capture module 63 and the backlight module 64 capture the digital image of the bill for recognizing to obtain a recognition result and output the bill from the bill outlet 62, wherein the bill outlet 62 can be designed two outlets so that the authentic bill is outputted from one of the outlets and the counterfeit currency bill is outputted from the other outlet.

It is understood that the invention can recognize currency bills issued by any of other countries or valuable papers such as stocks and lottery tickets by modifying the parameters stored in the data storage 4 and the neural network of the neural network recognition unit 3.

Although the present invention has been explained in relation to its preferred embodiment, it is to be understood that many other possible modifications and variations can be made without departing from the spirit and scope of the invention as hereinafter claimed.

What is claimed is:

1. An apparatus for recognizing counterfeit currency bill, comprising:
an image-capturing unit for obtaining and capturing a digital image of a currency bill to be validated or recognized;
a feature-capturing unit for capturing features of said digital image of the currency bill, wherein said features are characters, weights, system parameters, or threshold limits specific to said currency bill;
a data storage for storing a plurality of parameters, a plurality of features, a plurality of weights, a plurality of threshold limit values, or a plurality of system parameters; and
a neural network recognition unit having a plurality of sub-networks each updating a weight of the sub-networks based on a backpropagation algorithm, wherein the neural network recognition unit uses a plastic perception network as a training kernel performed by the sub-networks, and the neural network recognition unit compares one of the features of the digital image of the currency bill with that of an authentic bill and generates a comparison result for outputting a output unit.

2. The apparatus as claimed in claim 1, wherein the features comprise one or more embossing prints, one or more hidden lines, and a patterned register, a laser label and accuracy for double-printing.

3. The apparatus as claimed in claim 1, wherein the weights and the threshold limit values are used by the neural network recognition unit to construct a neural network and the features are fed into the neural network for comparison.

4. The apparatus as claimed in claim 1, wherein the capture unit is a back type charge coupled device (CCD)/complementary metal-oxide semiconductor (CMOS) based capture unit.

5. The apparatus as claimed in claim 1, wherein the capture unit is a back type optical scanner.

6. The apparatus as claimed in claim 1, wherein the neural network recognition unit is a microprocessor.

7. The apparatus as claimed in claim 1, wherein the neural network recognition unit is a digital signal processor (DSP).

8. The apparatus as claimed in claim 1, wherein the output means comprises a liquid crystal display (LCD), a light-emitting diode (LED), and a speaker.

9. The apparatus as claimed in claim 1, wherein the feature-capturing unit, the neural network recognition unit, and the data storage are formed together in an integrated circuit (IC).

10. The apparatus as claimed in claim 1, wherein the features further comprises one or more laser labels.

11. A method of recognizing counterfeit currency, comprising the steps of:
(A) providing a currency bill to be recognized;
(B) inserting said currency bill into an image-capturing unit for capturing a digital image of the currency bill;
(C) determining a denomination of the currency bill by analyzing the digital image of the currency bill;
(D) capturing features of the digital image of the currency bill by the feature-capturing unit;
(E) comparing the fetched features of the digital image of the currency bill with those of an authentic bill by neural network recognition unit by using an back propagation algorithm and a plastic perception network as a training kernel and generating a comparison result; and
(F) displaying the comparison result on output means.

12. The method as claimed in claim 11, wherein the capture unit is a back lit charge coupled device (CCD)/complementary metal-oxide semiconductor (CMOS) based capture unit.

13. The method as claimed in claim 11, wherein the features comprise one or more embossing prints, one or more hidden lines, and a patterned register.

14. The method as claimed in claim 11, wherein the data storage further comprises a plurality of parameters, a plurality of features, a plurality of weights, a plurality of threshold limit values, and a plurality of system parameters stored therein.

15. The method as claimed in claim 14, wherein the weights and the threshold limit values are used by the neural network recognition unit to construct a neural network and the features are fed into the neural network for comparison.

16. The method as claimed in claim 11, wherein the output means comprises a liquid crystal display (LCD), a light-emitting diode (LED), and a speaker.
